(19) United States
(12) Patent Application Publication
(10) Pub. No.: US 2026/0105380 A1
(43) Pub. Date: Apr. 16, 2026

(54) METHOD FOR UPDATING LARGE LANGUAGE MODEL, ELECTRONIC DEVICE AND STORAGE MEDIUM

(71) Applicant: Beijing Baidu Netcom Science Technology Co., Ltd., Beijing (CN)

(72) Inventors: Yucheng Wang, Beijing (CN); Zefeng Cai, Beijing (CN); Junliang Li, Beijing (CN); Yan Chen, Beijing (CN); Yu Ran, Beijing (CN); Ruiqing Zhang, Beijing (CN); Jing Liu, Beijing (CN)

(21) Appl. No.: 19/421,667

(22) Filed: Dec. 16, 2025

(30) Foreign Application Priority Data
Jun. 4, 2025 (CN) 202510740702.1

(51) Int. Cl. G06N 20/00

(52) U.S. Cl. CPC G06N 20/00

(57) ABSTRACT

A method for updating a parameter of a large language model is provided. The method may include: generating target text using the large language model based on a text generation request; determining facts to be relied on in the generation process of the target text according to the text generation request to obtain a target fact set; determining reward data according to the target fact set and an information set including unverified information in the target text; and updating the parameter of the large language model based on the reward data.

### CROSS-REFERENCE TO RELATED APPLICATIONS

This application claims the priority from Chinese Patent Application No. 202510740702.1, filed on Jun. 4, 2025, the entire disclosure of which is hereby incorporated by reference.

### TECHNICAL FIELD

The present disclosure relates to the field of artificial intelligence technologies, specifically to the fields of large language models and natural language understanding, and in particular to a method for updating a parameter of a large language model, an electronic device, and a storage medium, which are applicable to text generation scenarios.

### BACKGROUND

With the rapid development of generative artificial intelligence, applications based on LLM (Large Language Model) have become increasingly popular, including fields such as intelligent question answering, research assistants, and content creation. In many application scenarios, large language models are required to perform factually accurate long-form generation, including factual writing (such as biographies, long reports in specific professional fields, etc.) and long-form factual question answering (such as introduction of things, comparative analysis between different things, etc.). However, existing large language models generally have the problems of factual emptiness or factual fabrication in the process of long-form generation.

### SUMMARY

The present disclosure provides a method for updating a parameter of a large language model, an electronic device, and a storage medium.

According to a first aspect, there is provided a method for updating a parameter of a large language model, including: generating target text using a large language model according to a text generation request; determining facts that are to be relied on in the generation process of the target text according to the text generation request to obtain a target fact set; determining reward data according to the target fact set and an information set including unverified information in the target text; and updating a parameter of the large language model according to the reward data.

According to a second aspect, there is provided an electronic device, including: at least one processor; and a memory communicatively connected to the at least one processor; where the memory stores instructions executable by the at least one processor, and the instructions are executed by the at least one processor to enable the at least one processor to execute the method described in any implementation of the first aspect.

According to a third aspect, there is provided a non-transitory computer-readable storage medium storing computer instructions, where the computer instructions are used to enable a computer to execute the method described in any implementation of the first aspect.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The accompanying drawings are used to better understand the solution and do not constitute a limitation to the present disclosure. Among them:

FIG. 1 is a schematic diagram of an exemplary system architecture to which an embodiment of the present disclosure can be applied;

FIG. 2 is a flowchart of an embodiment of a method for updating a parameter of a large language model according to the present disclosure;

FIG. 3 is a schematic diagram of a data processing flow according to the present embodiment;

FIG. 4 is a schematic diagram of a process for determining a fact set according to the present embodiment;

FIG. 5 is a schematic diagram of an application scenario of the method for updating a parameter of a large language model according to the present embodiment;

FIG. 6 is a flowchart of another embodiment of a method for updating a parameter of a large language model according to the present disclosure;

FIG. 7 is a flowchart of an embodiment of a text generation method based on a large language model according to the present disclosure;

FIG. 8 is a structural diagram of an embodiment of an apparatus for updating a parameter of a large language model according to the present disclosure;

FIG. 9 is a structural diagram of an embodiment of a text generation apparatus based on a large language model according to the present disclosure;

FIG. 10 is a structural diagram of a computer system suitable for implementing the embodiments of the present disclosure.

### DETAILED DESCRIPTION OF EMBODIMENTS

The following describes exemplary embodiments of the present disclosure with reference to the accompanying drawings, including various details of the embodiments to facilitate understanding, which should be regarded as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted from the following description.

In the technical solution of the present disclosure, the collection, storage, use, processing, transmission, provision, and disclosure of user personal information involved all comply with relevant laws and regulations and do not violate public order and good customs.

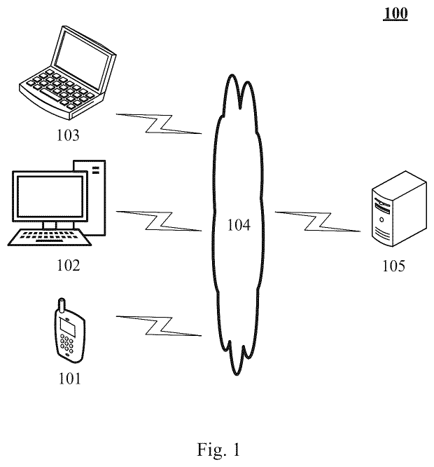

FIG. 1 shows an exemplary architecture 100 to which the method and apparatus for updating a parameter of a large language model, and the text generation method and apparatus based on a large language model of the present disclosure may be applied.

As shown in FIG. 1, the system architecture 100 may include terminal devices 101, 102, 103, a network 104, and a server 105. The terminal devices 101, 102, 103 are communicatively connected to form a topological network, and the network 104 serves as a medium for providing communication links between the terminal devices 101, 102, 103 and the server 105. The network 104 may include various connection types, such as wired, wireless communication links, or optical fiber cables.

The terminal devices 101, 102, 103 may be hardware devices or software that support network connection for data interaction and data processing. When the terminal devices 101, 102, 103 are hardware, they may be various electronic devices that support network connection and functions such as information acquisition, interaction, display, and processing, including but not limited to smartphones, tablet computers, e-book readers, laptop computers, and desktop computers. When the terminal devices 101, 102, 103 are software, they may be installed in the above-listed electronic devices. They may be implemented as, for example, multiple software pieces or software modules for providing distributed services, or as a single software piece or software module, which is not specifically limited herein.

The server 105 may be a server that provides various services, for example, a background processing server that obtains text generation requests sent by the terminal devices 101, 102, 103 and generates target texts corresponding to the text generation requests through a large language model. As an example, the server 105 may be a cloud server.

It should be noted that the server may be hardware or software. When the server is hardware, it may be implemented as a distributed server cluster composed of multiple servers, or as a single server. When the server is software, it may be implemented as multiple software pieces or software modules (such as software or software modules for providing distributed services), or as a single software piece or software module, which is not specifically limited herein.

It should also be noted that the method for updating a parameter of a large language model and the text generation method based on a large language model provided by the embodiments of the present disclosure are generally executed by a server, but the method does not exclude the possibility of being executed by a terminal device or cooperatively executed by a server and a terminal device. Correspondingly, each part (such as each unit) included in the apparatus for updating a parameter of a large language model and the text generation apparatus based on a large language model may be entirely disposed in the server, entirely disposed in the terminal device, or separately disposed in the server and the terminal device.

It should be understood that the number of terminal devices, networks, and servers in FIG. 1 is only schematic. According to implementation needs, there may be any number of terminal devices, networks, and servers. When the electronic device on which the method for updating a parameter of a large language model and the text generation method based on a large language model run does not need to perform data transmission with other electronic devices, the system architecture may only include the electronic device (such as a terminal device or a server) on which the method for updating a parameter of a large language model and the text generation method based on a large language model run.

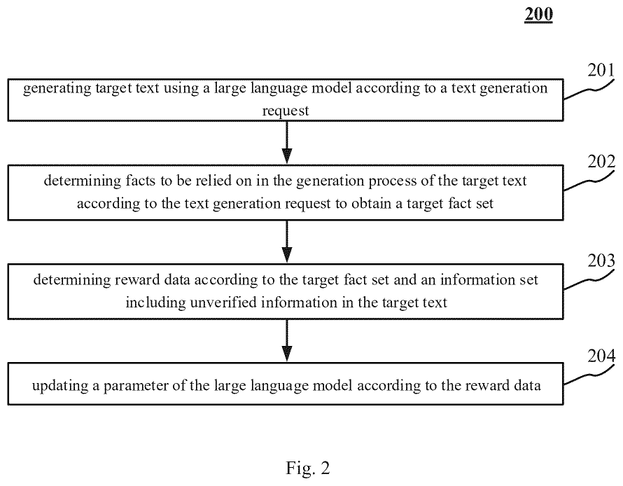

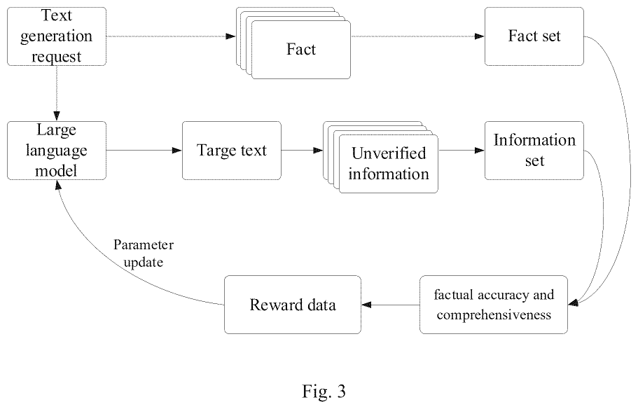

Please refer to FIG. 2, which is a flowchart of a method for updating a parameter of a large language model provided by an embodiment of the present disclosure. Continuing to refer to FIG. 3, which is a schematic diagram of a data processing flow of the method for updating a parameter of a large language model provided by an embodiment of the present disclosure. The flow 200 includes the following steps.

Step 201 includes generating target text using a large language model according to a text generation request.

In this embodiment, the execution subject of the method for updating a parameter of a large language model (for example, the server in FIG. 1) may obtain a text generation request from a remote or local location through a wired network connection or a wireless network connection, and generate target text using a large language model according to the text generation request.

The text generation request may be sent by a target object, such as a person, another intelligent device, an artificial intelligence assistant, or other objects.

A large language model is a large-scale language model built based on deep learning technology, mainly used to handle natural language processing tasks. By training based on large-scale text data, the model learns language patterns and structures, and can generate natural language text or understand natural language input. A large language model usually includes the following modules.

An input module is configured to receive text data input by the target object, such as text generation requests including questions, instructions, or conversation content;

A Preprocessing module is configured to perform preprocessing on the input text, including operations such as word segmentation, stop word removal, and text cleaning, to convert the text into a form that can be processed by the model;

An encoding module is configured to encode the preprocessed text into a vector form so that the model can understand and process it. Common encoding methods include word embedding and encoders in the Transformer architecture. Word embedding includes, for example, Word2Vec (Words to Vector) and GloVe (Global Vectors for Word Representation).

A model module: the core part, usually based on a deep learning architecture (such as Transformer), is responsible for processing the encoded text vectors for language understanding and generation. The model learns complex language patterns and semantic relationships through a multi-layer neural network structure.

A decoding module is configured to decodes the output vector of the model into natural language text, generate a reply or processing result for the user input. Decoding methods may include greedy decoding, beam search, etc.

An output module is configured to output the decoded text in a user-readable form, such as text displayed on a screen or speech synthesized from text.

A large language model may be applied in various text generation scenarios. For short-text generation, examples include but are not limited to automatic reply, copywriting generation, summary generation, email reply, question answering systems, tweet generation, and other scenarios; for long-text generation, examples include but are not limited to factual writing such as writing reports, technical documents, user manuals, biographies, news reports, and long-form factual question answering such as introduction of things and comparative analysis between different things.

In this embodiment, the text generation request may be input into the large language model as a Prompt of the large language model, and the large language model outputs the target text.

Step 202 includes determining facts to be relied on in the generation process of the target text according to the text generation request to obtain a target fact set.

In this embodiment, the execution subject may determine facts to be relied on in the generation process of the target text according to the text generation request to obtain a target fact set.

The facts to be relied on in the generation process of the target text refer to the facts existing in the text that corresponds to the text generation request and has factual comprehensiveness and accuracy.

As an example, first, natural language understanding is performed on the text generation request to determine the scenario the request belongs to; then, the method for determining the fact set is determined according to the scenario; finally, the determined determination method is used to determine the fact set to be relied on in the generation process of the target text according to the text generation request.

The corresponding relationship between scenarios and determination methods may be preset. For example, in the biographical writing scenario, the corresponding determination method is to obtain facts related to the life of the target person from various official websites to obtain the fact set.

As a further example, the text-generation request is first subjected to lexical and syntactic analyses and semantic-role labeling to extract structured information such as key entities, relations and events, while a pre-trained language model is employed to semantically interpret the request and produce a semantic-embedding vector that captures deep meaning of the request. Next, an existing knowledge graph that already contains massive entities and their inter-relations across multiple domains and topics is built or utilized; the entities and relations in the graph are classified and labeled to enable precise subsequent querying. Finally, the extracted structured information is used to perform path search and subgraph matching in the knowledge graph so as to locate the entities and relations relevant to the text-generation request; graph algorithms (e.g., shortest-path, PageRank, etc.) are applied to rank the information by importance, and the most relevant facts are extracted. The retrieved facts are then semantically fused and de-duplicated to ensure the target fact set is both concise and comprehensive, whereby the fact set is obtained.

In some optional implementations of this embodiment, the execution subject may perform the above step in the following manner.

The first step includes: adopting multiple preset determination methods to respectively determine facts to be relied on in the generation process of the target text according to the text generation request, so as to obtain initial fact sets.

Specifically, the first step includes: for each preset determination method among the preset determination methods, adopting the preset method to determine facts to be relied on in the generation process of the target text according to the text generation request to obtain an initial fact set; and combine the initial fact sets respectively corresponding to the preset determination methods to obtain multiple initial fact sets.

The preset determination methods and the number of preset determination methods may be specifically set according to actual conditions, including, for example, a determination method based on searching facts by a search system and a determination method based on generating facts by other large models.

Second step includes: obtaining the target fact set based on the initial fact sets in one-to-one correspondence with the preset determination methods.

As an example, for multiple facts belonging to multiple initial fact sets, pairwise matching is performed to determine fact groups, where each fact group includes mutually matching facts; the facts represented by the fact groups are added with the number greater than the set threshold to the target fact set.

In this implementation, by obtaining the target fact set based on the initial fact sets in one-to-one correspondence with the preset determination methods, the comprehensiveness and accuracy of the facts in the target fact set are improved.

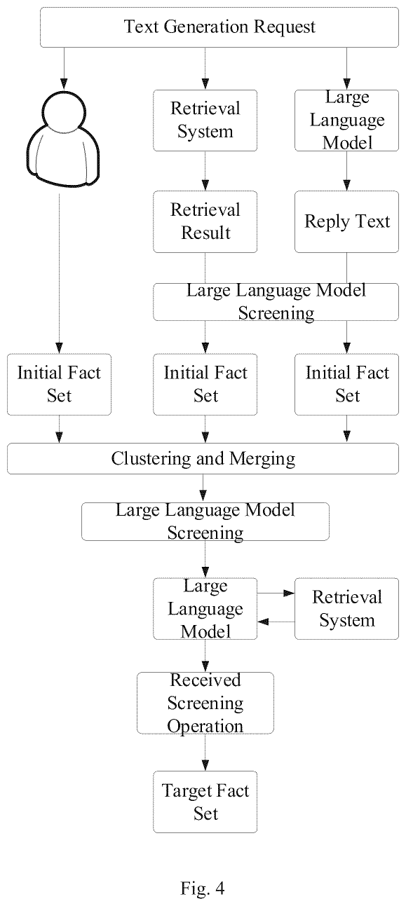

Continuing to refer to FIG. 4, a schematic diagram of a process for determining a fact set is shown.

In some optional implementations of this embodiment, the execution subject may perform the above first step in the following manner: adopting at least two of the following preset determination methods to respectively generate initial fact sets.

Method 1 includes: generating multiple reply texts corresponding to the text generation request through the large language model, and screening preliminary facts from the reply texts to obtain the initial fact set.

The text generation request is input into the large language model multiple times, or the text generation request and a prompt word instructing the large language model to generate multiple reply texts are input into the large language model, so as to obtain multiple reply texts; and all candidate facts included in the reply texts are clustered and merged to obtain an initial fact set.

Method 2 includes: screening preliminary facts from search results generated by a search system for the text generation request through the large language model to obtain the initial fact set.

The text generation request is input into the search system to obtain multiple search results; the search results and a prompt word representing extracting preliminary facts are input into the large language model, and with the help of the natural language understanding ability and logical reasoning ability of the large language model, preliminary facts are screened out from the search results to obtain the initial fact set.

To improve the reliability of the search results, the final search system to be adopted may be determined from each candidate search system based on evaluation indicators of multiple dimensions such as reliability, data comprehensiveness, and stability of each candidate search system.

To further improve the reliability of the search results, multiple search systems may also be determined from the candidate search systems, and through the large language model, preliminary facts are respectively screened out from the search results generated by the search systems for the text generation request, and then the screened preliminary facts are clustered and merged to obtain an initial fact set.

Method 3 includes: generating the initial fact set according to received input operations.

As an example, preliminary facts written by target personnel (such as human experts) may be received based on a display interface to generate an initial fact set.

In this implementation, the execution order of various preset determination methods is not limited. The multiple preset determination methods may be executed sequentially according to a preset order or simultaneously.

In this implementation, specific preset determination methods are provided, combining large language models, search systems, and manual work, which improves the comprehensiveness of preliminary facts in the initial fact set.

In some optional implementations of this embodiment, the execution subject may perform the above second step in the following manner.

First, preliminary facts in the initial fact sets are clustered and merged to obtain a merged set.

As an example, features of each preliminary fact, such as entities, relationships, time, location, etc. are extracted; an appropriate clustering algorithm, such as K-Means, DBSCAN (Density-Based Spatial Clustering of Applications with Noise), etc. is selected; the preliminary facts in the initial fact sets are clustered according to the extracted features; similar preliminary facts within each cluster are merged. A voting mechanism may be adopted, and the content recognized by most preliminary facts is used as the merged fact subject.

Then, preliminary facts are screened and checked in the merged set to obtain the target fact set.

As an example, the execution subject may adopt the following manner.

Internal consistency check includes: check whether there are logical contradictions between preliminary facts in the merged set.

External fact comparison includes: comparing and verifying preliminary facts with authoritative data sources.

Multi-source cross-validation includes: if preliminary facts involve multiple information sources, performing multi-source cross-validation.

In this implementation, by clustering, merging, screening, and verifying preliminary facts in the initial fact sets, the comprehensiveness and accuracy of the facts in the target fact set are ensured.

In some optional implementations of this embodiment, the execution subject may perform screening and verification of preliminary facts in the following manner to obtain the target fact set.

First, preliminary facts in the merged set are screened through the large language model to obtain a screened set.

As an example, the preliminary facts in the merged set and a prompt word prompting the large language model to perform fact screening are input into the large language model, and the preliminary facts obtained by screening by the large language model are added to the screened set.

Then, a query request corresponding to a preliminary fact in the screened set is generated, and a query result of the query request is generated through a search system.

For each preliminary fact in the screened set, a query request corresponding to the preliminary fact is generated; the query request is input into the search system, and the search system outputs the query result of the query request.

To improve the accuracy of the query result, for each preliminary fact, the type to which the preliminary fact belongs may be determined; and the search system corresponding to the type is adopted to generate the query result of the query request corresponding to the preliminary fact. The search system has high search accuracy and comprehensiveness for query requests of its corresponding type.

Then, preliminary facts in the screened set are verified based on the query result to obtain a verified set.

As an example, for each preliminary fact in the screened set, the consistency between the preliminary fact and the corresponding query result is determined; in response to determining that the preliminary fact and the corresponding query result are consistent, the preliminary fact is added to the verified set.

Finally, the target fact set is obtained according to a screening operation for preliminary facts in the verified set.

The execution subject may display the preliminary facts in the verified set to target personnel (such as human experts) through a display interface, and receive a screening operation for the preliminary facts in the verified set to obtain the target fact set.

In this implementation, combined with two-level screening by the large language model and manual screening operation, the accuracy of the facts in the target set is further improved.

Step 203 includes determining reward data according to the target fact set and an information set including unverified information in the target text.

In this embodiment, the execution subject may determine reward data according to the target fact set and an information set including unverified information in the target text.

As an example, first, checkpoint division is performed on the target text based on the natural language understanding result of the target text to obtain at least one unverified information corresponding to at least one checkpoint, so as to obtain an information set; then, each fact in the target fact set is matched with each unverified information in the information set to obtain a matching quantity. Finally, the reward data is determined according to the matching quantity. The matching quantity is positively correlated with the reward degree represented by the reward data.

As another example, on the basis of determining the matching quantity, the error quantity of incorrect unverified information may also be determined, and the reward data may be determined by combining the error quantity and the matching quantity. The reward degree represented by the reward data is positively correlated with the matching quantity and negatively correlated with the error quantity.

In some optional implementations of this embodiment, the execution subject may perform the above step 203 in the following manner.

First step includes: determining the accuracy and comprehensiveness of the unverified information in the information set according to the target fact set.

Accuracy represents the proportion of correct unverified information in the information set, and comprehensiveness represents the ratio of the number of unverified information in the information set to the number of facts in the target fact set.

Second step includes: determining the reward data according to the accuracy and comprehensiveness.

As an example, the accuracy and comprehensiveness may be summed or weighted summed to obtain the reward data.

In this implementation, the reward data is clarified based on the accuracy and comprehensiveness of the unverified information in the information set, providing fine-grained reward data, which helps to further improve the factual accuracy and comprehensiveness of the text generated by the large language model.

In some optional implementations of this embodiment, the execution subject may perform the above first step in the following manner to determine the accuracy and comprehensiveness.

First, a first quantity value of accurate facts in the target fact set that are consistent with the unverified information, a second quantity value of contradictory facts that are inconsistent with the unverified information, and a third quantity value of missing facts not covered by the unverified information are determined.

Accurate fact: the fact has appeared in the target fact set and is consistent with an unverified information in the information set.

Contradictory fact: the fact contradicts an unverified information in the information set.

Missing fact: the fact has not appeared in the target fact set.

Then, the accuracy and comprehensiveness are determined according to the first quantity value, the second quantity value, and the third quantity value.

As an example, a first score representing accuracy and a second score representing comprehensiveness may be respectively determined according to the first quantity value, the second quantity value, and the third quantity value.

In this implementation, the specific meanings of accurate facts, contradictory facts, and missing facts are clarified, as well as the specific manner of determining accuracy and comprehensiveness based on the respective quantity values of various facts, which can quickly and accurately determine the accuracy and comprehensiveness of the unverified information in the information set.

In some optional implementations of this embodiment, the execution subject may calculate the accuracy in the following manner: first, obtaining a fourth quantity value by combining the first quantity value and the second quantity value; then, determining the accuracy according to the first quantity value and the fourth quantity value.

Specifically, the first quantity value and the second quantity value are added to obtain a fourth numerical value; the ratio of the first quantity value to the fourth quantity value is used as the accuracy.

In this implementation, a specific manner of determining accuracy is provided, which helps to more accurately determine the accuracy of the unverified information in the information set.

In some optional implementations of this embodiment, the execution subject may calculate the comprehensiveness in the following manner: first, obtaining a fourth quantity value by combining the first quantity value and the second quantity value; then, obtaining a fifth quantity value by combining the first quantity value, the second quantity value, and the third quantity value; finally, determining the comprehensiveness according to the fourth quantity value and the fifth quantity value.

Specifically, the first quantity value and the second quantity value are added to obtain a fourth quantity value; the first quantity value, the second quantity value, and the third quantity value are added to obtain a fifth quantity value; and the ratio of the fourth quantity value to the fifth quantity value is used as the comprehensiveness.

In this implementation, a specific manner of determining comprehensiveness is provided, which helps to more accurately determine the comprehensiveness of the unverified information in the information set.

As an example, when the text generation request is “Introduce the situation of the 7th National Population Census”, assuming the target text output by the large language model is: “The 7th National Population Census was conducted in 2020. The standard time point of this population census was zero hour on Oct. 1, 2020. The results show that the total national population was 1,443,497,378.” The facts to be relied on in the generation process of the target text are:

The 7th National Population Census was conducted in 2020.

The standard time point of the 7th National Population Census was zero hour on Nov. 1, 2020.

The census results show that the total national population was approximately 1.44 billion.

The census results show that the population of the Hong Kong Special Administrative Region was approximately 7.47 million.

The census results show that the population of the Macao Special Administrative Region was approximately 680,000.

According to the facts in the target fact set and the unverified information in the information set, it is determined that:

Accurate fact: The target text mentions that “The 7th National Population Census was conducted in 2020”, which is consistent with a fact “conducted in 2020” in the target fact set.

Contradictory fact: The target text mentions that “the standard time point of the population census was zero hour on Oct. 1, 2020”, which contradicts a fact “zero hour on Nov. 1, 2020” in the target fact set.

Accurate fact: The target text mentions that “the total national population announced in the results of the 7th National Population Census was 1,443,497,378”, which is consistent with the expression of a fact “approximately 1.44 billion” in the target fact set.

Missing fact: The target text does not mention the population of the Hong Kong Special Administrative Region.

Missing fact: The target text does not mention the population of the Macao Special Administrative Region.

In this case, the factual accuracy score is calculated as ⅔ and the factual completeness score is calculated as ⅗. The score obtained by weighted averaging the two scores is used as a reward signal for reinforcement learning to guide the parameter update of the large language model.

Step 204 includes updating a parameter of the large language model according to the reward data.

In this embodiment, the execution subject may update parameters of the large language model according to the reward data.

After determining the reward signal, an RL (Reinforcement Learning) method may be used, and the large language model may be used as a policy model in reinforcement learning to update the parameters of the large language model. The policy function is optimized through gradient ascent, and the gradient of the reward data to the parameters is calculated to update the parameters of the large language model.

By iteratively executing the above steps 201 to 204 until a preset end condition is reached, a trained large language model is obtained. The preset end condition is, for example, that the training times exceeds a preset number threshold, the training time exceeds a preset time threshold, or the loss of the large language model converges.

In some optional implementations of this embodiment, the execution subject may perform the above step in the following manner: generating multiple target texts using the large language model according to the text generation request.

As an example, the text generation request and instruction data representing generating multiple target texts are input into the large language model, and the large language model generates multiple target texts.

For each generated target text, the execution subject may determine reward data corresponding to the target text according to the target fact set corresponding to the target text and the information set including the unverified information in the target text.

In this implementation, the execution subject may perform the above step in the following manner: updating parameters of the large language model according to multiple reward data in one-to-one correspondence with the target texts.

The pieces of reward data in one-to-one correspondence with the target texts are generally different. The factual accuracy and comprehensiveness of the target text are positively correlated with the reward data corresponding to the target text. Updating the parameters of the large language model according to the pieces reward data in one-to-one correspondence with the target texts can make the large language model more inclined to generate target texts with higher factual accuracy and comprehensiveness, which helps to further improve the parameter update efficiency of the large language model, as well as the factual accuracy and comprehensiveness of the text generated by the updated large language model.

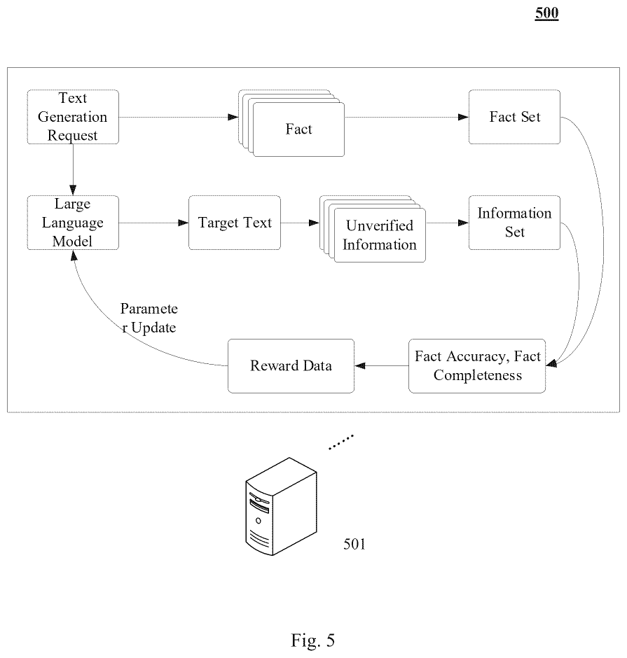

Continuing to refer to FIG. 5, which is a schematic diagram of an application scenario of the method for updating a parameter of a large language model according to the present embodiment. A large language model is deployed in the server 501, which is required to generate long texts with factual accuracy and comprehensiveness. To achieve this goal, first, target text is generated using the large language model according to a text generation request, where the text generation request is, for example, a request representing generating a biography or a technical report; then, facts to be relied on in the generation process of the target text are generated according to the text generation request to obtain a target fact set; then, reward data is determined according to the target fact set and an information set including unverified information in the target text; finally, parameters of the large language model are updated according to the reward data.

In this embodiment, a method for updating a parameter of a large language model is provided. Based on the facts to be relied on in the text generation process, the method provides effective and accurate reward signals for the factual accuracy and comprehensiveness of the text generated by the large language model, which can effectively avoid the problems of factual emptiness or factual fabrication of the large language model in the text generation process, especially in the long-text generation process, and help improve the factual accuracy and comprehensiveness of the text generated by the large language model.

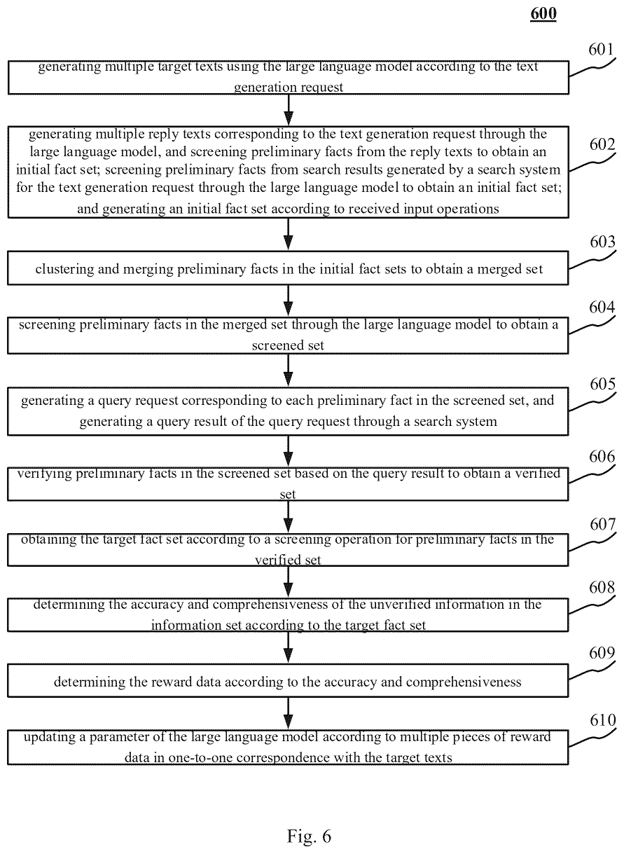

Continuing to refer to FIG. 6, a schematic flow 600 of another embodiment of the method for updating a parameter of a large language model according to the present disclosure is shown. The flow 600 includes the following steps.

Step 601 includes generating multiple target texts using the large language model according to the text generation request.

Step 602 includes generating multiple reply texts corresponding to the text generation request through the large language model, and screening preliminary facts from the reply texts to obtain an initial fact set; screening preliminary facts from search results generated by a search system for the text generation request through the large language model to obtain an initial fact set; and generating an initial fact set according to received input operations.

Step 603 includes clustering and merging preliminary facts in the initial fact sets to obtain a merged set.

Step 604 includes screening preliminary facts in the merged set through the large language model to obtain a screened set.

Step 605 includes generating a query request corresponding to each preliminary fact in the screened set, and generating a query result of the query request through a search system.

Step 606 includes verifying preliminary facts in the screened set based on the query result to obtain a verified set.

Step 607 includes obtaining the target fact set according to a screening operation for preliminary facts in the verified set.

Step 608 includes determining the accuracy and comprehensiveness of the unverified information in the information set according to the target fact set.

Step 609 includes determining the reward data according to the accuracy and comprehensiveness.

Step 610 includes updating a parameter of the large language model according to multiple pieces of reward data in one-to-one correspondence with the target texts.

Compared with the above flow 200, the flow 600 of the method for updating a parameter of a large language model in this embodiment specifically illustrates the generation process of the target fact set, the determination process of the reward data, and the parameter update process based on the pieces of reward data in one-to-one correspondence with the target texts, which further improves the factual accuracy and comprehensiveness of the text generated by the large language model.

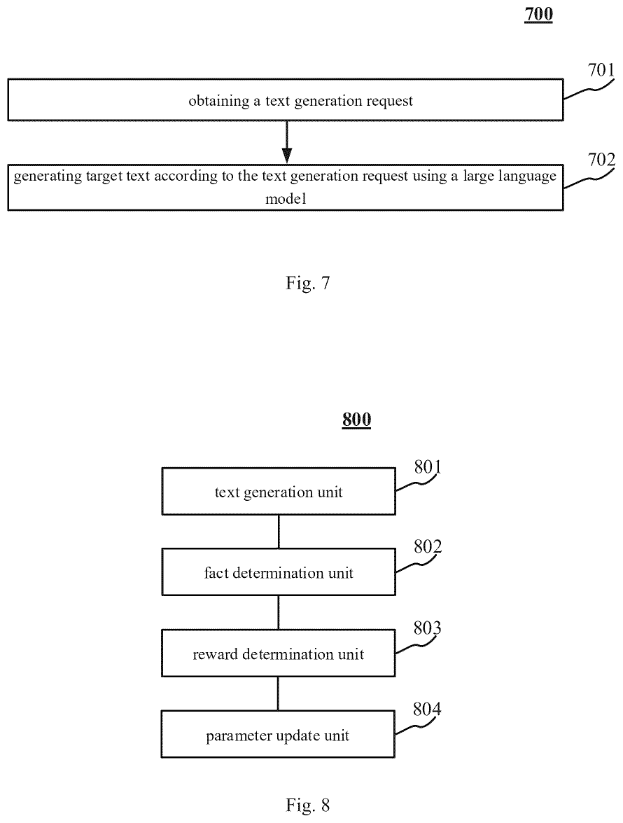

Continuing to refer to FIG. 7, a flowchart of a text generation method based on a large language model provided by an embodiment of the present disclosure is shown. The flow 700 includes the following steps.

Step 701 includes: obtaining a text generation request.

In this embodiment, the execution subject of the text generation method based on a large language model (for example, the server in FIG. 1) may obtain a text generation request from a remote or local location through a wired network connection or a wireless network connection.

The text generation request may be a request in a text generation scenario. For short-text generation, examples include but are not limited to automatic reply, copywriting generation, summary generation, email reply, question answering systems, tweet generation, and other scenarios; for long-text generation, examples include but are not limited to factual writing such as writing reports, technical documents, user manuals, biographies, news reports, and long-form factual question answering such as introduction of things and comparative analysis between different things.

Step 702 includes generating target text according to the text generation request using a large language model.

In this embodiment, the text generation request may be input into the large language model, and the large language model generates the target text based on its powerful natural language understanding ability and logical reasoning ability.

The large language model is parameter-updated based on the above embodiments 200 and 600 to ensure that the generated target text has factual accuracy and comprehensiveness. It should be noted that during the application process of the large language model, the parameters of the large language model may also be updated according to the above embodiments 200 and 600.

In this embodiment, the large language model ensures that the generated target text has factual accuracy and comprehensiveness.

Continuing to refer to FIG. 8, as an implementation of the methods shown in the above figures, the present disclosure provides an embodiment of an apparatus for updating a parameter of a large language model. This system embodiment corresponds to the method embodiment shown in FIG. 2, and the system can be specifically applied to various electronic devices.

As shown in FIG. 8, the apparatus 800 for updating a parameter of a large language model includes: a text generation unit 801 configured to generate target text using a large language model according to a text generation request; a fact determination unit 802 configured to determine facts to be relied on in the generation process of the target text according to the text generation request to obtain a target fact set; a reward determination unit 803 configured to determine reward data according to the target fact set and an information set including unverified information in the target text; and a parameter update unit 804 configured to update a parameter of the large language model according to the reward data.

In some optional implementations of this embodiment, the fact determination unit 802 is further configured to: adopt multiple preset determination methods to respectively determine facts to be relied on in the generation process of the target text according to the text generation request, so as to obtain initial fact sets; obtain the target fact set based on the initial fact sets in one-to-one correspondence with the preset determination methods.

In some optional implementations of this embodiment, the fact determination unit 802 is further configured to: adopt at least two of the following preset determination methods to respectively generate initial fact sets: generate multiple reply texts corresponding to the text generation request through the large language model, and screen preliminary facts from the reply texts to obtain the initial fact set; and screen preliminary facts from search results generated by a search system for the text generation request through the large language model to obtain the initial fact set; generate the initial fact set according to received input operations.

In some optional implementations of this embodiment, the fact determination unit 802 is further configured to: cluster and merge preliminary facts in the initial fact sets to obtain a merged set; and screen and verify preliminary facts in the merged set to obtain the target fact set.

In some optional implementations of this embodiment, the fact determination unit 802 is further configured to: screen preliminary facts in the merged set through the large language model to obtain a screened set; generate a query request corresponding to each preliminary fact in the screened set, and generate a query result of the query request through a search system; verify preliminary facts in the screened set based on the query result to obtain a verified set; and obtain the target fact set according to a screening operation for preliminary facts in the verified set.

In some optional implementations of this embodiment, the reward determination unit 803 is further configured to: determine the accuracy and comprehensiveness of the unverified information in the information set according to the target fact set; and determine the reward data according to the accuracy and comprehensiveness.

In some optional implementations of this embodiment, the reward determination unit 803 is further configured to: determine in the target fact set a first quantity value of accurate facts consistent with the unverified information, a second quantity value of contradictory facts inconsistent with the unverified information, and a third quantity value of missing facts not covered by the unverified information; and determine the accuracy and the comprehensiveness according to the first quantity value, the second quantity value, and the third quantity value.

In some optional implementations of this embodiment, the reward determination unit 803 is further configured to: obtain a fourth quantity value by combining the first quantity value and the second quantity value; and determine the accuracy according to the first quantity value and the fourth quantity value.

In some optional implementations of this embodiment, the reward determination unit 803 is further configured to: obtain a fourth quantity value by combining the first quantity value and the second quantity value; obtain a fifth quantity value by combining the first quantity value, the second quantity value, and the third quantity value; and determine the comprehensiveness according to the fourth quantity value and the fifth quantity value.

In some optional implementations of this embodiment, the text generation unit 801 is further configured to: generate multiple target texts using the large language model according to the text generation request; and the parameter update unit 804 is further configured to: update a parameter of the large language model according to multiple reward data in one-to-one correspondence with the plurality of target texts.

In this embodiment, an apparatus for updating a parameter of a large language model is provided. Based on the facts to be relied on in the text generation process, the apparatus provides effective and accurate reward signals for the factual accuracy and comprehensiveness of the text generated by the large language model. The apparatus can effectively avoid the problems of factual emptiness or factual fabrication of the large language model in the text generation process, especially in the long-text generation process, and help improve the factual accuracy and comprehensiveness of the text generated by the large language model.

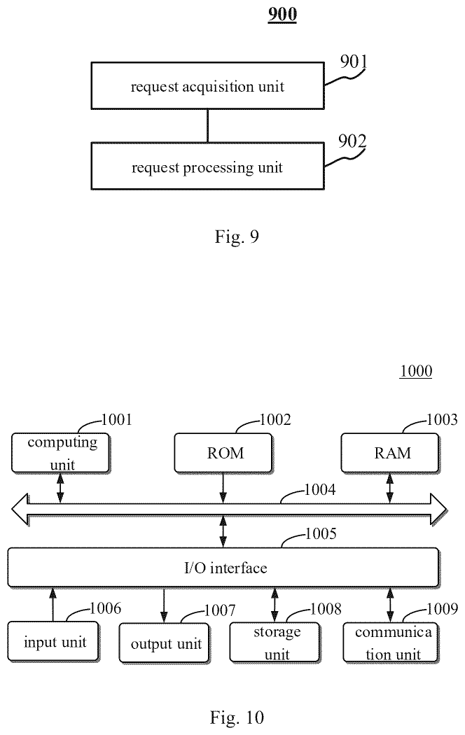

Continuing to refer to FIG. 9, as an implementation of the methods shown in the above figures, the present disclosure provides an embodiment of a text generation apparatus based on a large language model. This system embodiment corresponds to the method embodiment shown in FIG. 7, and the system can be specifically applied to various electronic devices.

As shown in FIG. 9, the text generation apparatus 900 based on a large language model includes: a request acquisition unit 901 configured to obtain a text generation request; and a request processing unit 902 configured to generate target text according to the text generation request using a large language model.

The large language model is parameter-updated based on the above embodiment 800 to ensure that the generated target text has factual accuracy and comprehensiveness.

In this embodiment, the large language model ensures that the generated target text has factual accuracy and comprehensiveness.

According to an embodiment of the present disclosure, the present disclosure further provides an electronic device, which includes: at least one processor; and a memory communicatively connected to the at least one processor; where the memory stores instructions executable by the at least one processor, and the instructions are executed by the at least one processor to enable the at least one processor to implement the method for updating a parameter of a large language model and the text generation method based on a large language model described in any of the above embodiments when executed.

According to an embodiment of the present disclosure, the present disclosure further provides a readable storage medium storing computer instructions, which are used to enable a computer to implement the method for updating a parameter of a large language model and the text generation method based on a large language model described in any of the above embodiments when executed.

An embodiment of the present disclosure provides a computer program product, which, when executed by a processor, can implement the method for updating a parameter of a large language model and the text generation method based on a large language model described in any of the above embodiments.

FIG. 10 shows a schematic block diagram of an exemplary electronic device 1000 that can be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processors, cellular phones, smart phones, wearable devices, and other similar computing devices.

The components shown herein, their connections and relationships, and their functions are merely examples, and are not intended to limit the implementations of the present disclosure described and/or required herein.

As shown in FIG. 10, the device 1000 includes a computing unit 1001, which can execute various appropriate actions and processes according to a computer program stored in a read-only memory (ROM) 1002 or a computer program loaded from a storage unit 1008 into a random access memory (RAM) 1003. In the RAM 1003, various programs and data required for the operation of the device 1000 can also be stored. The computing unit 1001, the ROM 1002, and the RAM 1003 are connected to each other through a bus 1004. An input/output (I/O) interface 1005 is also connected to the bus 1004.

Multiple components in the device 1000 are connected to the I/O interface 1005, including: an input unit 1006, such as a keyboard, a mouse, etc.; an output unit 1007, such as various types of displays, speakers, etc.; a storage unit 1008, such as a magnetic disk, an optical disk, etc.; and a communication unit 1009, such as a network card, a modem, a wireless communication transceiver, etc. The communication unit 1009 allows the device 1000 to exchange information/data with other devices through a computer network such as the Internet and/or various telecommunication networks.

The computing unit 1001 may be various general-purpose and/or special-purpose processing components with processing and computing capabilities. Examples of the computing unit 1001 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 1001 executes each of the methods and processes described above, such as the method for updating a parameter of a large language model. For example, in some embodiments, the method for updating a parameter of a large language model may be implemented as a computer software program tangibly embodied in a machine-readable medium, such as the storage unit 1008. In some embodiments, part or all of the computer program may be loaded into and/or installed on the device 1000 via the ROM 1002 and/or the communication unit 1009. When the computer program is loaded into the RAM 1003 and executed by the computing unit 1001, one or more steps of the method for updating a parameter of a large language model described above may be executed. Alternatively, in other embodiments, the computing unit 1001 may be configured to execute the method for updating a parameter of a large language model in any other suitable manner (for example, by means of firmware).

Various implementations of the systems and technologies described herein above may be implemented in digital electronic circuit systems, integrated circuit systems, field programmable gate arrays (FPGA), application specific integrated circuits (ASIC), application specific standard products (ASSP), systems on a chip (SOC), complex programmable logic devices (CPLD), computer hardware, firmware, software, and/or combinations thereof. These various implementations may include: being implemented in one or more computer programs that may be executed and/or interpreted on a programmable system including at least one programmable processor, which may be a dedicated or general-purpose programmable processor that may receive data and instructions from a storage system, at least one input device, and at least one output device, and transmit data and instructions to the storage system, the at least one input device, and the at least one output device.

The program code for implementing the methods of the present disclosure may be written in any combination of one or more programming languages. These program codes may be provided to a processor or controller of a general-purpose computer, a special-purpose computer, or other programmable apparatus for updating a parameter of a large language model, so that the program code, when executed by the processor or controller, causes the functions/operations specified in the flowcharts and/or block diagrams to be implemented. The program code may be executed entirely on a machine, partly on a machine, partly on a machine as a stand-alone software package and partly on a remote machine, or entirely on a remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media would include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), optical storage devices, magnetic storage devices, or any suitable combination of the foregoing.

To provide interaction with a user, the systems and technologies described herein may be implemented on a computer having: a display device (e.g., a CRT (cathode ray tube) or LCD (liquid crystal display) monitor) for displaying information to the user; and a keyboard and a pointing device (e.g., a mouse or a trackball) through which the user may provide input to the computer. Other types of devices may also be used to provide interaction with a user; for example, feedback provided to the user may be any form of sensory feedback (e.g., visual feedback, auditory feedback, or tactile feedback); and input from the user may be received in any form, including acoustic input, speech input, or tactile input.

The systems and technologies described herein may be implemented in a computing system that includes a background component (e.g., as a data server), or a computing system that includes a middleware component (e.g., an application server), or a computing system that includes a front-end component (e.g., a user computer having a graphical user interface or a web browser through which the user may interact with implementations of the systems and technologies described herein), or a computing system that includes any combination of such background, middleware, or front-end components. The components of the system may be interconnected by any form or medium of digital data communication (e.g., a communication network). Examples of communication networks include a local area network (LAN), a wide area network (WAN), and the Internet.

A computer system may include a client and a server. The client and the server are generally remote from each other and typically interact via a communication network. The relationship of client and server arises by virtue of computer programs running on the respective computers and having a client-server relationship to each other. The server may be a cloud server, also known as a cloud computing server or a cloud host, which is a host product in the cloud computing service system to solve the defects of high management difficulty and weak business scalability in traditional physical hosts and Virtual Private Server (VPS) services; it may also be a server of a distributed system or a server combined with a blockchain.

According to the technical solution of the embodiments of the present disclosure, a method and apparatus for updating a parameter of a large language model are provided. Based on the facts to be relied on in the text generation process, it provides effective and accurate reward signals for the factual accuracy and comprehensiveness of the text generated by the large language model. It can effectively avoid the problems of factual emptiness or factual fabrication of the large language model in the text generation process, especially in the long-text generation process, and help improve the factual accuracy and comprehensiveness of the text generated by the large language model.

It should be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for updating a parameter of a large language model, comprising:
generating target text using the large language model according to a text generation request;
determining facts to be relied on in the generation process of the target text according to the text generation request to obtain a target fact set;
determining reward data according to the target fact set and an information set including unverified information in the target text; and
updating the parameter of the large language model according to the reward data.

2. The method according to claim 1, wherein the determining facts to be relied on in the generation process of the target text according to the text generation request to obtain a target fact set comprises:
adopting a plurality of preset determination methods to respectively determine facts to be relied on in the generation process of the target text according to the text generation request, so as to obtain initial fact sets;
obtaining the target fact set based on the plurality of initial fact sets in one-to-one correspondence with the plurality of preset determination methods.

3. The method according to claim 2, wherein the adopting a plurality of preset determination methods to respectively determine facts to be relied on in the generation process of the target text according to the text generation request to obtain initial fact sets comprises:
adopting at least two of following preset determination methods to respectively generate the initial fact sets:
generating a plurality of reply texts corresponding to the text generation request through the large language model, and screening preliminary facts from the plurality of reply texts to obtain the initial fact set;
screening preliminary facts from search results generated by a search system for the text generation request through the large language model to obtain the initial fact set; or
generating the initial fact set according to received input operations.

4. The method according to claim 2, wherein the obtaining the target fact set based on the plurality of initial fact sets in one-to-one correspondence with the plurality of preset determination methods comprises:
clustering and merging preliminary facts in the plurality of initial fact sets to obtain a merged set; and
screening and verifying preliminary facts in the merged set to obtain the target fact set.

5. The method according to claim 4, wherein the screening and verifying preliminary facts in the merged set to obtain the target fact set comprises:
screening preliminary facts in the merged set through the large language model to obtain a screened set;
generating a query request corresponding to each preliminary fact in the screened set, and generating a query result of the query request through a search system;
verifying preliminary facts in the screened set based on the query result to obtain a verified set; and
obtaining the target fact set according to a screening operation for preliminary facts in the verified set.

6. The method according to claim 1, wherein the determining reward data according to the target fact set and the information set including unverified information in the target text comprises:
determining accuracy and comprehensiveness of the unverified information in the information set according to the target fact set; and
determining the reward data according to the accuracy and comprehensiveness.

7. The method according to claim 6, wherein the determining the accuracy and comprehensiveness of the unverified information in the information set according to the target fact set comprises:
determining, in the target fact set, a first quantity value of accurate facts consistent with the unverified information, a second quantity value of contradictory facts inconsistent with the unverified information, and a third quantity value of missing facts not covered by the unverified information; and determining the accuracy and the comprehensiveness according to the first quantity value, the second quantity value, and the third quantity value.

8. The method according to claim 7, wherein the determining the accuracy according to the first quantity value, the second quantity value, and the third quantity value comprises:
obtaining a fourth quantity value by combining the first quantity value and the second quantity value; and
determining the accuracy according to the first quantity value and the fourth quantity value.

9. The method according to claim 7, wherein the determining the comprehensiveness according to the first quantity value, the second quantity value, and the third quantity value comprises:
obtaining a fourth quantity value by combining the first quantity value and the second quantity value;
obtaining a fifth quantity value by combining the first quantity value, the second quantity value, and the third quantity value; and
determining the comprehensiveness according to the fourth quantity value and the fifth quantity value.

10. The method according to claim 1, wherein the generating target text using the large language model according to the text generation request comprises:
generating a plurality of target texts using the large language model according to the text generation request; and
the updating a parameter of the large language model according to the reward data comprises:
updating the parameter of the large language model according to a plurality of pieces of reward data in one-to-one correspondence with the plurality of target texts.

11. The method according claim 1, further comprising:
obtaining a new text generation request; and
generating new target text according to the new text generation request through the large language model with the updated parameter.

12. An electronic device, comprising:
at least one processor; and
a memory communicatively connected to the at least one processor; wherein,
the memory stores instructions executable by the at least one processor, and the instructions are executed by the at least one processor to enable the at least one processor to perform operations comprising:
generating target text using the large language model according to a text generation request;
determining facts to be relied on in the generation process of the target text according to the text generation request to obtain a target fact set;
determining reward data according to the target fact set and an information set including unverified information in the target text; and
updating the parameter of the large language model according to the reward data.

13. The electronic device according to claim 12, wherein the determining facts to be relied on in the generation process of the target text according to the text generation request to obtain a target fact set comprises:
adopting a plurality of preset determination methods to respectively determine facts to be relied on in the generation process of the target text according to the text generation request, so as to obtain initial fact sets;
obtaining the target fact set based on the plurality of initial fact sets in one-to-one correspondence with the plurality of preset determination methods.

14. The electronic device according to claim 13, wherein the adopting a plurality of preset determination methods to respectively determine facts to be relied on in the generation process of the target text according to the text generation request to obtain initial fact sets comprises:
adopting at least two of following preset determination methods to respectively generate the initial fact sets:
generating a plurality of reply texts corresponding to the text generation request through the large language model, and screening preliminary facts from the plurality of reply texts to obtain the initial fact set;
screening preliminary facts from search results generated by a search system for the text generation request through the large language model to obtain the initial fact set; or
generating the initial fact set according to received input operations.

15. The electronic device according to claim 13, wherein the obtaining the target fact set based on the plurality of initial fact sets in one-to-one correspondence with the plurality of preset determination methods comprises:
clustering and merging preliminary facts in the plurality of initial fact sets to obtain a merged set; and
screening and verifying preliminary facts in the merged set to obtain the target fact set.

16. The electronic device according to claim 15, wherein the screening and verifying preliminary facts in the merged set to obtain the target fact set comprises:
screening preliminary facts in the merged set through the large language model to obtain a screened set;
generating a query request corresponding to each preliminary fact in the screened set, and generating a query result of the query request through a search system;
verifying preliminary facts in the screened set based on the query result to obtain a verified set; and
obtaining the target fact set according to a screening operation for preliminary facts in the verified set.

17. The electronic device according to claim 12, wherein the determining reward data according to the target fact set and the information set including unverified information in the target text comprises:
determining accuracy and comprehensiveness of the unverified information in the information set according to the target fact set; and
determining the reward data according to the accuracy and comprehensiveness.

18. The electronic device according to claim 17, wherein the determining the accuracy and comprehensiveness of the unverified information in the information set according to the target fact set comprises:
determining, in the target fact set, a first quantity value of accurate facts consistent with the unverified information, a second quantity value of contradictory facts inconsistent with the unverified information, and a third quantity value of missing facts not covered by the unverified information; and
determining the accuracy and the comprehensiveness according to the first quantity value, the second quantity value, and the third quantity value.

19. The electronic device according to claim 18, wherein the determining the accuracy according to the first quantity value, the second quantity value, and the third quantity value comprises:
obtaining a fourth quantity value by combining the first quantity value and the second quantity value; and
determining the accuracy according to the first quantity value and the fourth quantity value.

20. A non-transitory computer-readable storage medium storing computer instructions, wherein the computer instructions are used to enable a computer to perform operations comprising:
generating target text using the large language model according to a text generation request;
determining facts to be relied on in the generation process of the target text according to the text generation request to obtain a target fact set;
determining reward data according to the target fact set and an information set including unverified information in the target text; and
updating the parameter of the large language model according to the reward data.
